(19) United States
(12) Patent Application Publication
(10) Pub. No.: US 2006/0029054 A1
(43) Pub. Date: Feb. 9, 2006

(54) System and method for modeling and dynamically deploying services into a distributed networking architecture

(75) Inventors: Jochen Breh, Stuttgart (DE); Gerd Breiter, Wildberg (DE); Samuel Mueller, Winterthur (CH); Hendrik Wagner, Stuttgart (DE)

Correspondence Address: William A. Kinnaman, Jr.;IBM Corporation - MS P386, 2455 South Road, Poughkeepsie, NY, 12601, US

(73) Assignee: International Business Machines Corporation, Armonk, NY (US)

(21) Appl. No.: 11/106,319

(22) Filed: Apr. 14, 2005

(30) Foreign Application Priority Data
Apr. 29, 2004 (EP) 04101815.1

(51) Int. Cl. H04L 12/50

(52) U.S. Cl. 370/385

(57) ABSTRACT

The present invention describes a new system and method for modeling and dynamically deploying services into a distributed networking architecture, especially in a service-oriented architecture. The service container being part of distributed networking architecture exposes its functionality as services. It provides a registration service for deploying service descriptions. Having created a new service description in any declarative description language (i.e. a description of a (stateful) service e.g. a stateful Web service), the description provider invokes the registration service at the service container that allows to register (i.e. deploy) that new service description during runtime without restarting service container. The service container is responsible to analyze and check the submitted new service description for validity, to store the service description and to make it available for interested services consumers for instantiation. If a new service has been successfully registered, a new service interface for accessing that new service is automatically created by the service container. Interested services consumers may query the hosting environment for the available services being hosted and to subsequently instantiate a new service. A service consumer may then invoke any exposed service operation on a given service instance which generally follows a request response pattern.

### CROSS-REFERENCE TO RELATED APPLICATION

This application claims the priority benefit under 35 U.S.C. § 119 of European patent application 004101815.1, filed Apr. 29, 2004, and incorporated herein by reference.

### BACKGROUND OF THE INVENTION

1. Field of the Invention

The present invention relates to the field of distributed networking architecture, and in particular to a system and method for modeling and dynamically deploying services into a distributed networking architecture, especially into a service container that is part of a service-oriented architecture which consists of a resource provider, service consumer, and service container (i.e. hosting environment) which provides services to a service consumer.

2. Description of the Related Art

Today's IT environments are marked by the need to provide means for interoperability between numerous kinds of systems and applications. Most these systems and applications potentially retain state information. Because of their stateful characteristics, systems and applications alike can be regarded as resources. In order to provide homogeneous access to the state of such resources, in a service-oriented architecture resources and their respective states can be exposed as services (e.g. Web services) through functional interfaces that pertain to an individual resource's state.

If access to an arbitrary resource (i.e. a physical or logical system or application) is to be provided by exposing the resource's state and functionality as service (i.e. through a functional interface), a service interface and implementation (e.g. Web services, grid services, CORBA etc.) that encapsulate the respective resource must be developed using an arbitrary programming language (e.g. Java, Net etc.).

The problem that is encountered today as new services are developed and deployed lies in the static nature of the state-of-the-art application development and deployment. The current development and deployment process is very rigid and does not allow modifying existing services during runtime. If a new service is to be developed or an existing service is to be modified, the entire application life cycle has to be started again and new features have to be added to the application's source code, which then generally has to be compiled, further described, packaged and transferred into the target hosting environment, which will then offer the service's functionality for use (depending on the programming language or methodology used, there might be even more steps to carry through before a service can be used. More on that further below). In addition, if existing services shall be combined into a higher-level composite service, a developer has to provide the code that combines the functionality of two existing services. This development and combining existing services is always done during buildtime (the application or service is not active or executed) and not during runtime.

In order to explain in more detail how new services are currently developed and deployed into a hosting environment, FIG. 1 shows an exemplary and schematic representation of how development and deployment are done in the case of J2EE (i.e. the Java 2 Enterprise Edition platform). The illustration differentiates between a buildtime (where the application or service is developed in a static manner) and a runtime (where the finished service is made available in the hosting environment and accessible by service consumers). If a new service is to be developed and deployed, a service or application developer must carry through a number of predefined activities. First of all, the service has to be developed (this includes the specification of the functional interface of the service as well as the functional implementation of the service's logic. Secondly, the finished service must be compiled into Java byte code. Then, the new code must be further described by adding additional information in the form of a so-called deployment descriptor, which specifies additional behavioral properties of the application service (e.g. transactional behavior or security settings). After having described the code with one or more deployment descriptors, the descriptors and the code must be packaged together into e.g. a jar or a .ear file (representing a J2EE executable). Subsequently, this executable has to be transferred into a predefined location within the future hosting environment (this is generally done by various means of file transfer like e.g. FTP). In the following the developer or deployer might have to create the needed database tables, and map the application's stateful parts to the respective tables. Finally, the executable can be installed into the hosting environment using various means (dropping it into a directory and restarting the server or invoking an installation client or administration interface). Normally, this signifies that the hosting environment (i.e. the J2EE application server) will have to be stopped, the executable will be installed and the server will be restarted afterwards. Only after successful restart can the new service eventually be used by service consumers (i.e. new stateful service instances can be created and operations on these instances can be invoked). As an aside, the described static process is not only valid for stateful services but for services and application development and deployment in general.

If several services are to be combined into a higher-level composite service, the new composite service has to be developed in exactly the same manner as a single service. The entire development steps (during buildtime) are needed for every new service, making also combinations of existing service very rigid and cumbersome.

The problems of the state-of-the-art approach are as follows. The static development and deployment processes make dynamic service development and compositions of existing services into more complex composite services very rigid and cumbersome. In addition, services (i.e. the application implementations behind them) cannot be dynamically configured during runtime (e.g. transactional behavior or security features cannot be adjusted during runtime but the adjustments need to be done during buildtime and the services need to be re-deployed afterwards). Likewise, all kinds of modifications to a service enforce re-development of the adapted code. Further, if resources of any kind are to be represented as services, they need to implement additional protocol layers in order to expose their state information and functionality into a service-oriented world.

### SUMMARY OF THE PRESENT INVENTION

It is an object of the invention to provide a system and method for developing and deploying services in a networking architecture avoiding the disadvantages of the prior art.

The present invention contemplates a new system and method for modeling and dynamically deploying services within a distributed networking architecture, especially in a service-oriented architecture. The service container that is part of a distributed networking architecture exposes its functionality as services. It provides a registration service for deploying service descriptions. Having created a new service description in any declarative description language (i.e. a description of a (stateful) service e.g. a stateful Web service), the description provider invokes the registration service at the service container that allows one to register (i.e. deploy) that new service description during runtime without restarting the service container. The service container is responsible to analyze and check the submitted new service description for validity, to store the service description and to make it available for interested service consumers for instantiation. If a new service has been successfully registered, a new service interface for accessing that new service is automatically created by the service container. Interested service consumers may query the hosting environment for the available services being hosted and to subsequently instantiate a new service. A service consumer may then invoke any exposed service operation on a given service instance which generally follows a request-response pattern.

### BRIEF DESCRIPTION OF THE DRAWINGS

The above, as well as additional objectives, features and advantages of the present invention will be apparent in the following detailed written description.

The novel features of the present invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a state-of-the-art Web service development and deployment process;

FIG. 2 shows the deployment method according to the present invention;

FIG. 3 shows the involved parties in a distributed networking architecture required for carrying the inventive deployment method according to FIG. 2;

FIG. 4 shows the components of the involved parties of the distributed networking architecture for carrying out the inventive deployment method according to FIG. 3;

FIG. 5 shows an interaction diagram of the components of the involved parties in one form of the invention;

FIGS. 6A-6G show the activities when a new representation of a resource of any kind of service is registered with the service container according to the present invention; and

FIGS. 7A-7L show a preferred embodiment of the inventive system and method for dynamic deployment of services in a Web service architecture using a Web service container.

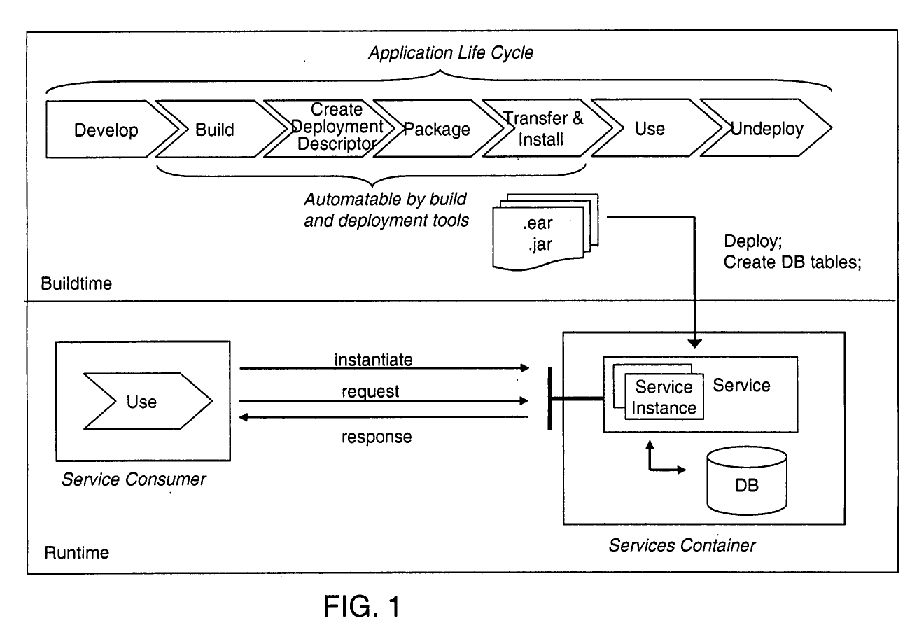

### DESCRIPTION OF THE PREFERRED EMBODIMENTS

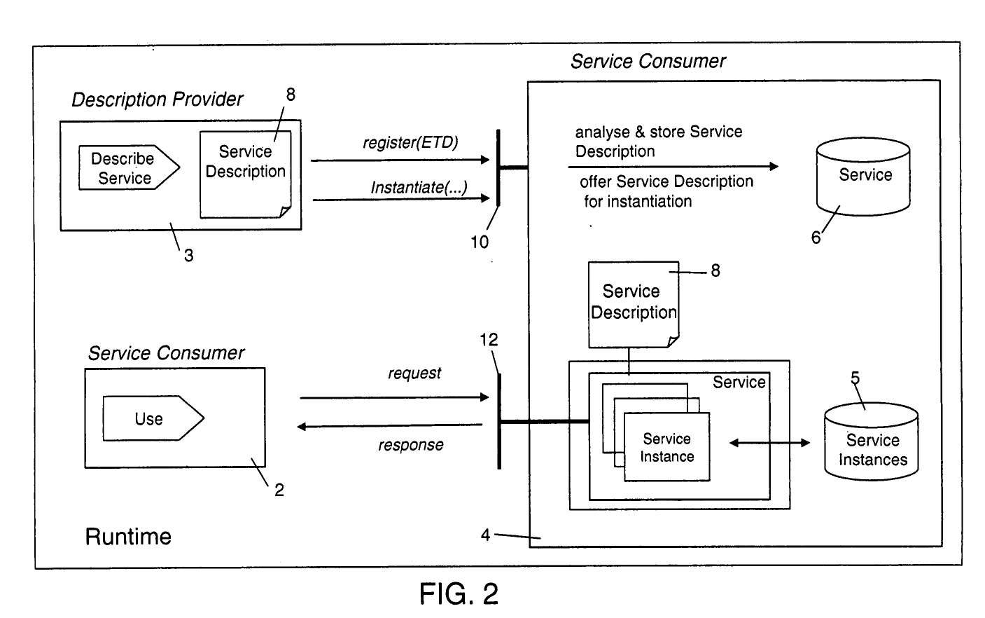

With respect to FIG. 2, there is shown a schematic representation of the inventive method of development and dynamic deployment of services in a service-oriented architecture which includes at least a description provider 3, a hosting environment 4 (service container), and a service consumer 2. Having created a service description in any declarative description language 8—i.e. a description of a (stateful) service e.g. a stateful Web service)—the description provider 3 invokes an operation on the hosting environment 4, which allows one to register 10 (i.e. deploy) a new service description that can represent any kind of resource (e.g. stateful resource). After a new service description has been registered with the hosting environment 4—which can happen during runtime without restarting the hosting environment in order to register or instantiate a new service—the hosting environment 4 (e.g. application server or service container etc.) is responsible to analyze and check the submitted service description for validity, to store the described service and to make it available for interested service consumers 2 for instantiation. Interested service consumers 2 may query the hosting environment 4 for the available services being hosted and subsequently instantiate a new service instance of any existing service. If a service instance has been created, it can be accessed via the service interface 12 (e.g. Web service interface) corresponding to the underlying service, which is automatically exposed by the hosting environment 4 (since the hosting environment also exposes its operations as services, it may also be termed a hosting service). A service consumer 2 may then invoke any exposed service operation on a given service instance (behind the service interface derived from the described service type), which generally follows a request response-pattern.

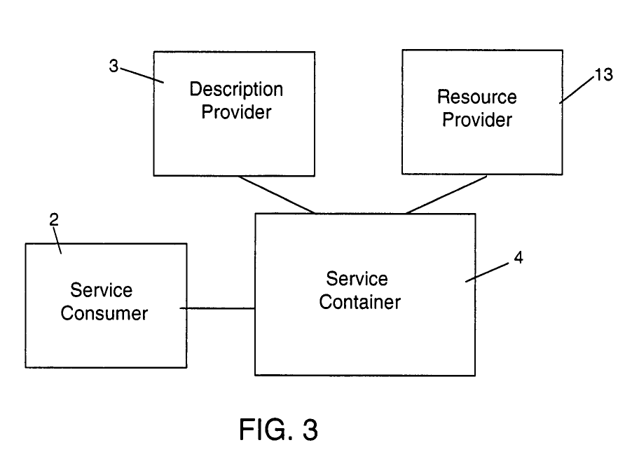

FIG. 3 shows the involved parties in a distributed networking architecture required for carrying the inventive deployment method according to FIG. 2:
1. The service container 4 (i.e. hosting environment), which is preferably a stateful service container, offers a managed runtime environment and provides transparent transaction handling, persistence, a messaging subsystem and a workflow engine, which controls the execution of the service instance's workflow-driven operations. This service container can run on any kind of data processing unit like a normal PC, a special server etc. that has a processor, working memory, secondary storage and ideally network (wired or wireless) access).
2. The resource provider 13, who offers physical or logical resources, which shall be offered to potential service consumers 2 via the service container 4.
3. The description provider 3, who provides the service container 4 with descriptions of a dedicated services (potentially representing a stateful and physical resources).
4. The service consumer 2, who is interested in using one or more services offered by and residing in the service container 4.

All these involved parties may be connected via a network and communicate and exchange information within this infrastructure.

The present invention describes in detail how a resource provider 13 may offer any kind of (stateful) resource to a service consumer 2. In order to do this, a description provider 3 (can be the resource provider itself) must create a service description representing the resource(s) of his choice. Having described such a representation of his resource (source code), he is able to register the description with the service container 4. There, an interested service consumer 2 may create an individual instance of the service description (=type of the resource) and interact with it via a protocol of choice (defined by the offering of the service container, at least Web service over SOAP should be provided).

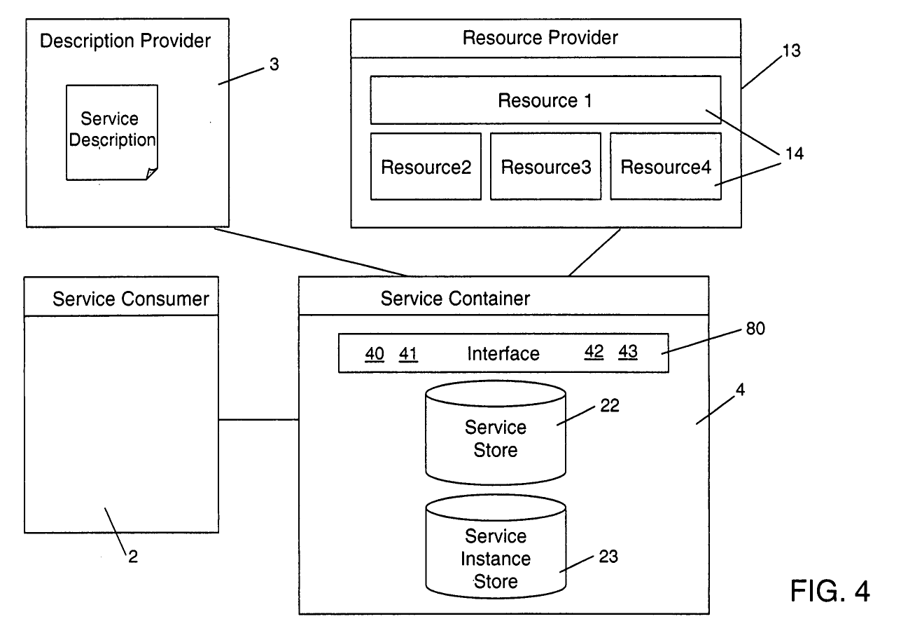

FIG. 4 shows the components of the involved parties.

The service container 4 has at least the following components:
1. A service description data store 22, containing the service descriptions already registered with the service container 4.
2. A service instance data store 23, containing all instances that belong to the service descriptions in the service store 22.
3. An interface 80 comprising the following set of sub-interfaces 40, 43 which are needed to carry out the present invention:
   a. A register service interface 40, which allows a description provider to register a service description of a new service representing any kind of resource, and
   b. A service interface 43 which is automatically created when the registration of a service description has been successful.

The following further sub-interfaces should preferably be included in the service container:
1. An information retrieval interface 41, which may be used to query the container about deployed services and service instances; and
2. An instantiate service interface 42, which allows a service consumer to instantiate a service description offered by the container.

Finally the following further interfaces may be additionally included in the service container:
1. A delete service instance interface, which allows a service consumer to explicitly delete an instance that is not used anymore;
2. An interface for every service that was formerly registered with the container. Using this interface and a unique handle pointing to an individual instance conforming to this interface, a service consumer can access and operate on an instance; and
3. A deregister description interface, which is used to deregister service descriptions that are not used any more.

The resource provider 13 offers access to physical and logical resources 14, e.g. CPU (computing cycle time), storage (physical means for the storage of data), network (network resources with various qualities of service i.e. regarding bandwidth, throughput, etc.), software service (i.e. database or web servers), billing services, metering services (services which measure usage of resources on time level, load level, throughput level etc. for any service consumers and provide this metering information for entity service consumers), accounting services (services which use the data collected via billing and metering to create invoices for the pay-as-you-go-usage of the resources). The resource provider 13 may provide access to its resources by means of various protocols such as CIM, SNMP, SSH, telnet etc.

The role of the resource provider 13 and that of the description provider 3 might be played by the same party. Both the description provider as well as the resource provider may also act in the role of the service consumer.

The description provider 3 is responsible to create descriptions of services and to register the created descriptions with the service container, which may be preferably a stateful service container. In order to create the service description, the description provider 3 adheres to a grammar that specifies the syntax and semantics of some kind of declarative description language (i.e. XML-based). The grammar is used in order to specify descriptions of the services reflecting the resources. In order to register the descriptions with the service container 4, an endpoint reference pointing to the container's register interface is needed. In addition, the description provider needs to have some kind of information or some notion of the resource that shall be represented by the service, which shall be described. This may also comprise protocol-specific information (in order to access the physical resource directly in the background).

The service consumer 2 only needs to know how to address the service container's interfaces 43 (i.e. an endpoint reference/URL pointing to the endpoint of the container's interfaces is needed). All other information needed by the service consumer 2 can be obtained dynamically by querying the stateful service provider's interfaces.

The service consumer 2 may have caches or stores in order to durably keep handles referencing services and services instances etc. This is, however, only an optimization and must not be provided imperatively. All this information can also be obtained on the fly, using the stateful services container's information retrieval interface.

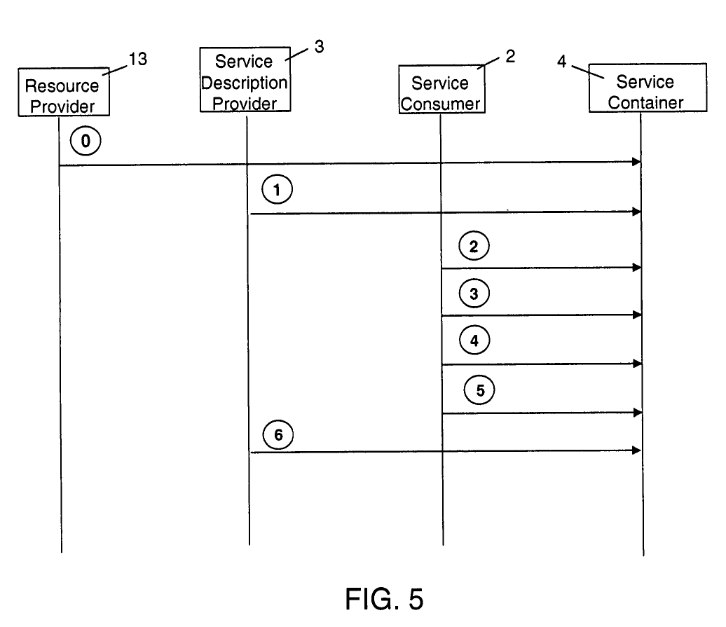

FIG. 5 shows an interaction diagram of the components of the involved parties in one form of the invention.

FIG. 5 gives an overview on how all the components interact, shows the dynamic deployment or registration of new service descriptions and demonstrates the subsequent instantiation of service instances, e.g. stateful service instances, and the interaction with them.

First of all, some kind of resource must be provided by the resource provider (0). Actual access to these resources may be provided in various ways (i.e. via SNMP, CIM, SSH, Telnet etc.).

After that, the description provider creates and registers descriptions of services, which reflect the actual resources (1).

As soon as there are services available in the service container—which is preferably a stateful Web service container—service consumers may retrieve information about the registered services and instances (2; if there are any).

After service descriptions have been registered, they may be instantiated by interested service consumers (3).

Via automatically exposed service interfaces of the respectively registered service descriptions, service consumers can subsequently interact with the service instances directly. Thus, service consumers may invoke operations on the service instances and thus change the service instance's state (4).

If a service instance is not used any more, a service consumer may choose to delete this instance (5).

Service descriptions, which have no corresponding service instances and which are not used any longer, may be deregistered from the stateful service container (6).

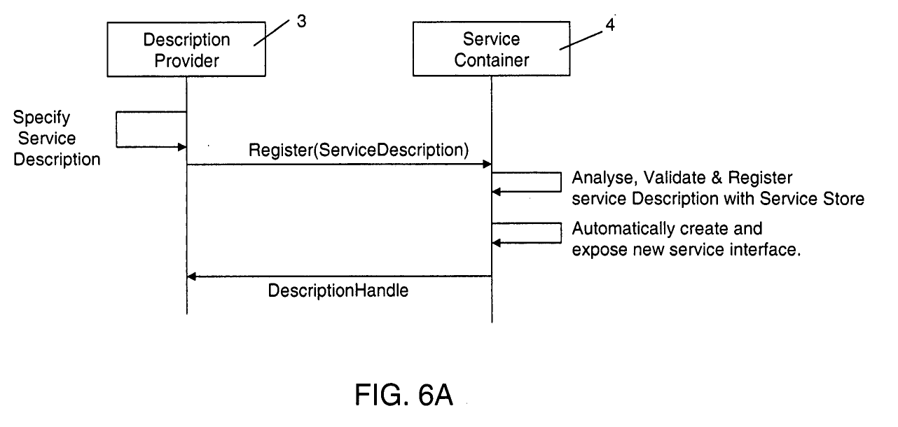

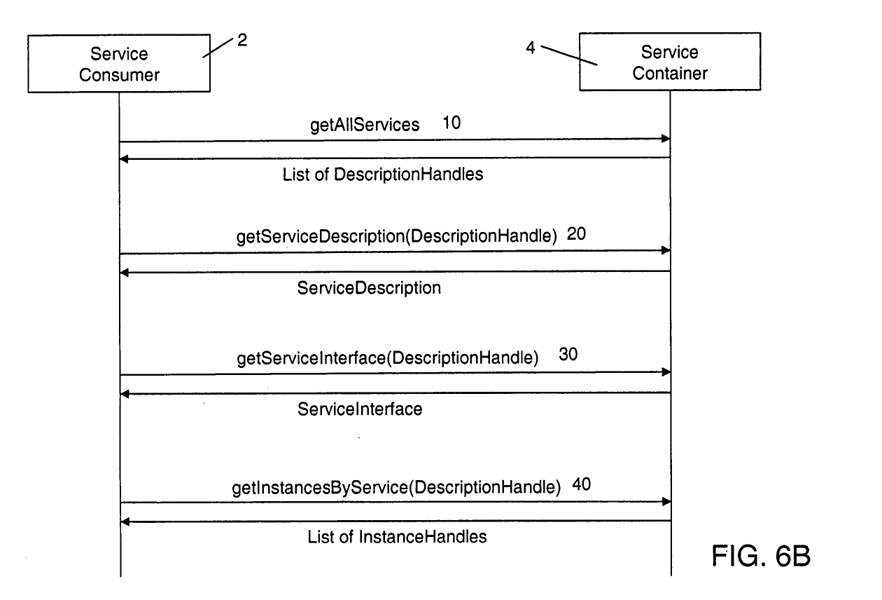

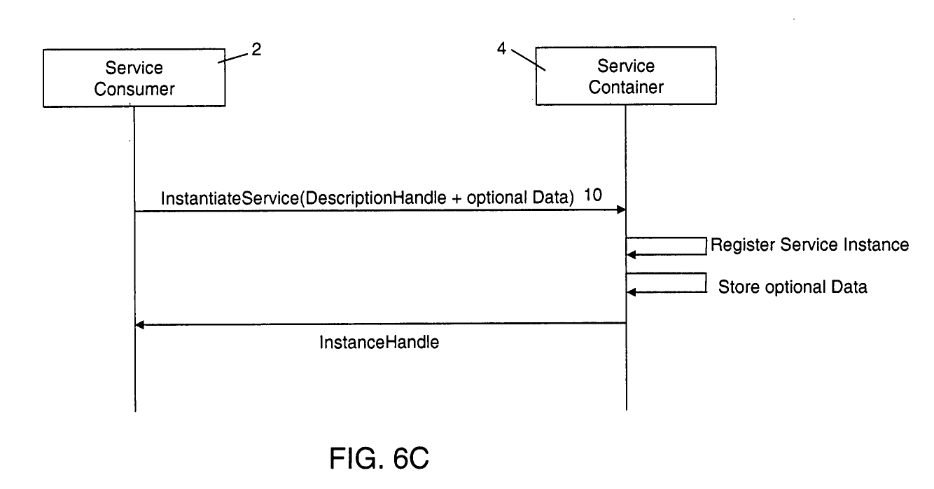

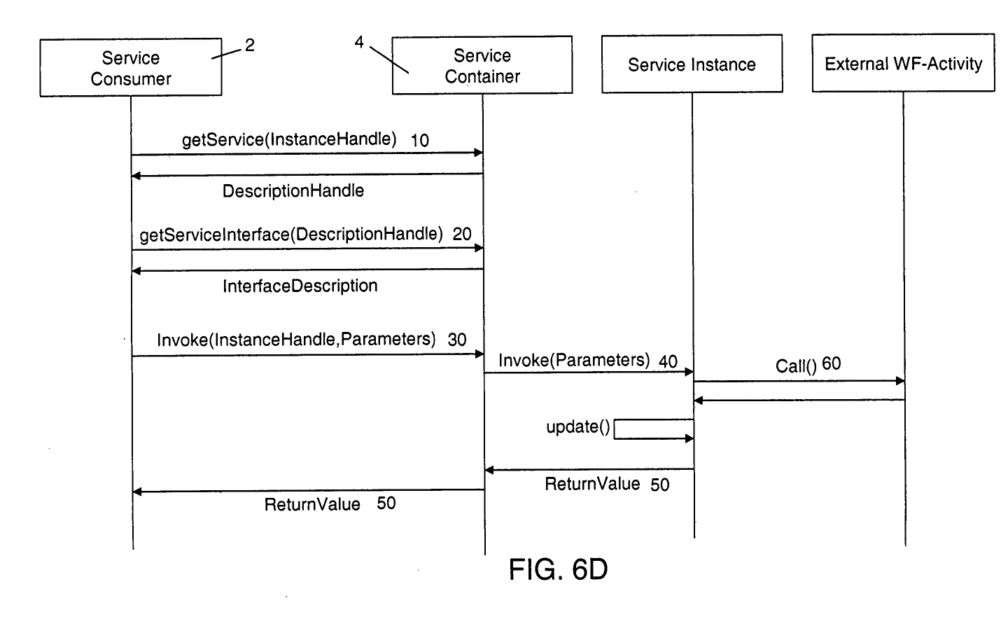

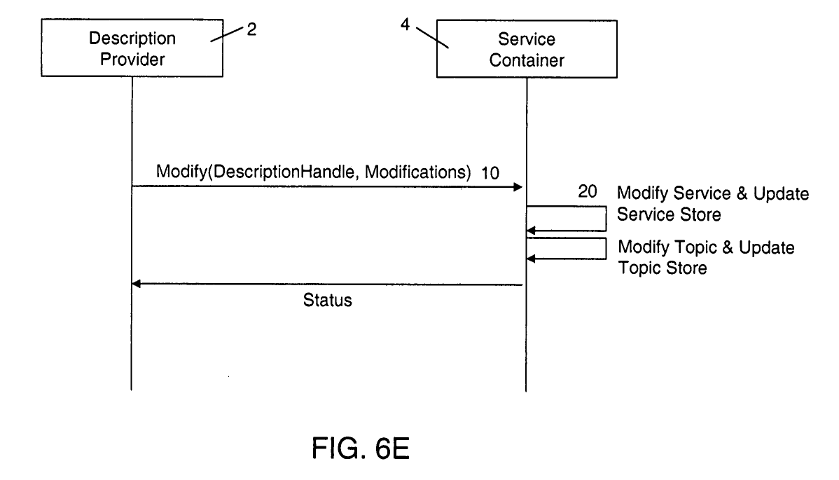

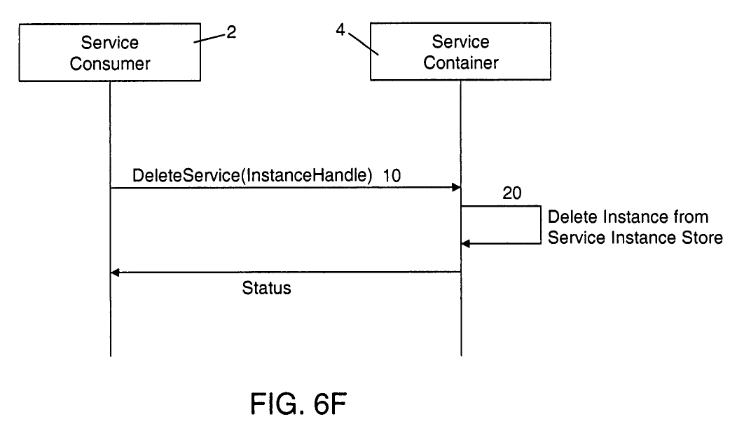

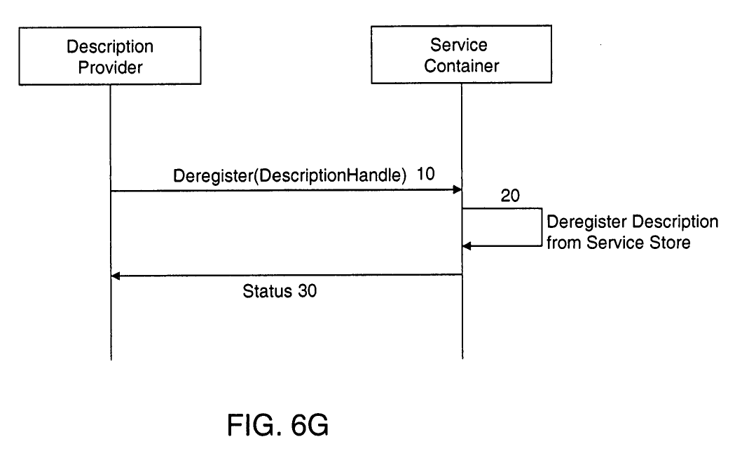

FIGS. 6A-6G show the interactions when a new representation of a resource of any kind of service is registered with the service container according to the present invention.

The following activities happen when a new representation of a resource or any kind of service is registered with the service container (see FIG. 6A):

The description provider 3 defines and declares a service description of its choice (i.e. conforming to some kind of physical or logical resource to be virtualized) using the means of some kind of declarative description language. The description of the new service can be done automatically (using templates) or manually.

The description provider 3 invokes some kind of register (service description) operation of the service container 4 and thereby registers the service description. The service container 4 analyses, validates, and registers the service description representing a new type of resource (e.g. stateful resource) with the service store. After successful registration, the service description is offered for instantiation.

If the register operation was successful, the service container 4 returns a unique ID, a description handle (referring to the registered service), to the description provider 3.

In order to retrieve information about registered service, their descriptions and interfaces as well as existing service instances, the following methods are provided:

Retrieve Service Information (see FIG. 6B):

In a first step, a service consumer 2 may retrieve a list of description handles (unique references to service descriptions that have already been registered with the service container 4) (step 10).

Having such a description handle, the service consumer 2 may retrieve the service description corresponding to the description handle (step 20).

In addition, the service consumer 2 can also obtain the service interface that is automatically exposed by the service registered (i.e. WSDL in the case of Web services) by submitting the description handle as a parameter (step 30).

Furthermore, the service consumer 2 can also retrieve a list of instance handles, which refer to all service instances that belong to the service described by the submitted description handle (step 40).

Before a service can be used by a service consumer 2, it needs to be instantiated:

Instantiate a Service (see FIG. 6C):

In order to instantiate a registered service, the service consumer 2 invokes an InstantiateService( . . . ) operation and passes the description handle, which is to be the type of the service instance, as well as optional data (for instantiation) as parameters (step 10). The optional data may include state information for the service instance's initialization, needed quality-of-service requirements for the respective entity etc.

The service container 2 creates a new service instance and registers the new instance with the service instance store. The service instance conforms to the interface prescribed by the service.

The optionally submitted data is also made persistent in the service instance store.

If the instantiation was successful, the service consumer 2 obtains a unique instance handle, referring to the newly created service instance.

Existing service instances can be accessed via the service interface of the underlying service. Various interactions between a service consumer 2 and the service instance are conceivable i.e. operation invocations, notification generation and reception, calls to external workflow activities and dynamic alteration or setting of quality-of-service properties. Four typical interaction schemes are described in the following:

Use Service Instance (see FIG. 6D):

If the service consumer 2 already retains a reference to the desired service instance, he may submit this instance handle to the service container 4.

As a result of the submitted instance handle, the service consumer 2 receives the corresponding description handle, which refers to the service of the service instance (step 10).

Before the service consumer 2 can interact with the service instance, the service interface must be obtained by submitting the description handle of the service to which the service instance conforms (step 20; the service interface may i.e. be described in WSDL).

After the service consumer 2 has obtained the service interface, any operation that is exposed via the interface may be used to interact with the service instance (step 30). When an operation is invoked, the instance handle must be passed together with possible other parameters.

The service container 4 intercepts the operation call at the service interface and routes it to the correct service instance (indicated by the submitted instance handle) (step 40).

If the invoked operation is a complex workflow-driven operation (which is interpreted and managed by a workflow execution engine), an external activity provider may provide one or more activities contained in the workflow operation (step 60). These activities are called in the order prescribed by the workflow operation definition.

The operation potentially updates the state of the service instance.

A potential return value is returned via the service container to the service consumer 2.

Modify Service Description (see FIG. 6E):

In order to modify an existing service, the description provider calls a modify operation and submits a description handle together with the desired modifications to the description as parameters (step 10).

The service container 4 subsequently modifies the service and updates the service data store (step 20).

In addition, possible topics are added or removed from the topic registry, hence modifications are made persistent in the topic store.

Unused services instances can be deleted:

Delete Service Instance (see FIG. 6F):

If an existing service instance is not needed any more, the service consumer 2 may invoke a delete operation and pass the desired instance handle pointing to the service instance which is to be deleted (step 10).

The container subsequently deletes the instance from the service instance data store (step 20).

In the following, the service consumer 2 receives a status code indicating whether the delete operation was successful.

Service descriptions that are not any longer needed may be deregistered dynamically after all service instances conforming to this type have ceased to exist:

Deregister Service Description (see FIG. 6G):

If an existing service is not needed any more, the service consumer 2 may invoke a deregister operation and pass the desired description handle pointing to the service description which is to be deregistered (step 10).

The service container 4 subsequently deregisters the description from the service store (step 20).

In the following, the service consumer 2 receives a status code indicating whether the deregister operation was successful (step 30).

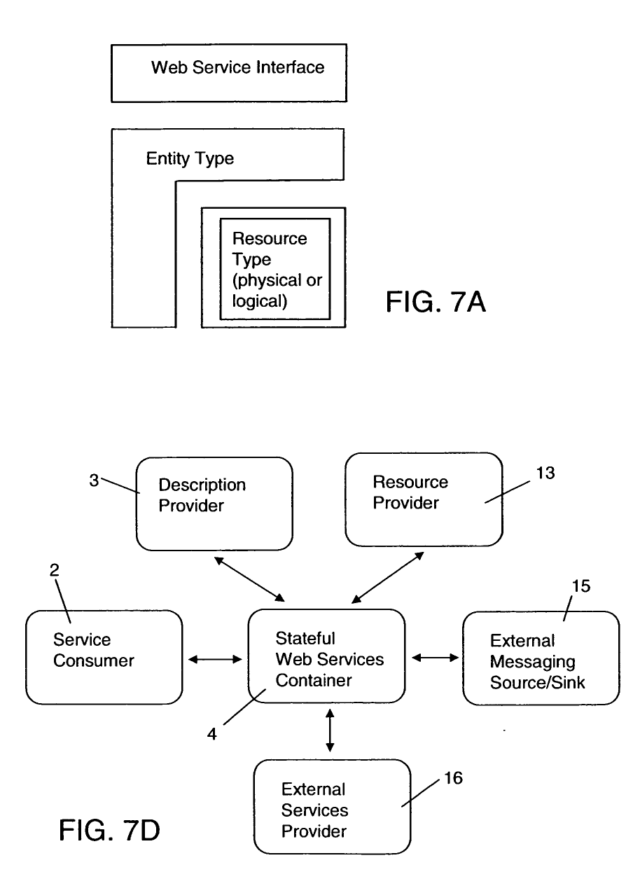

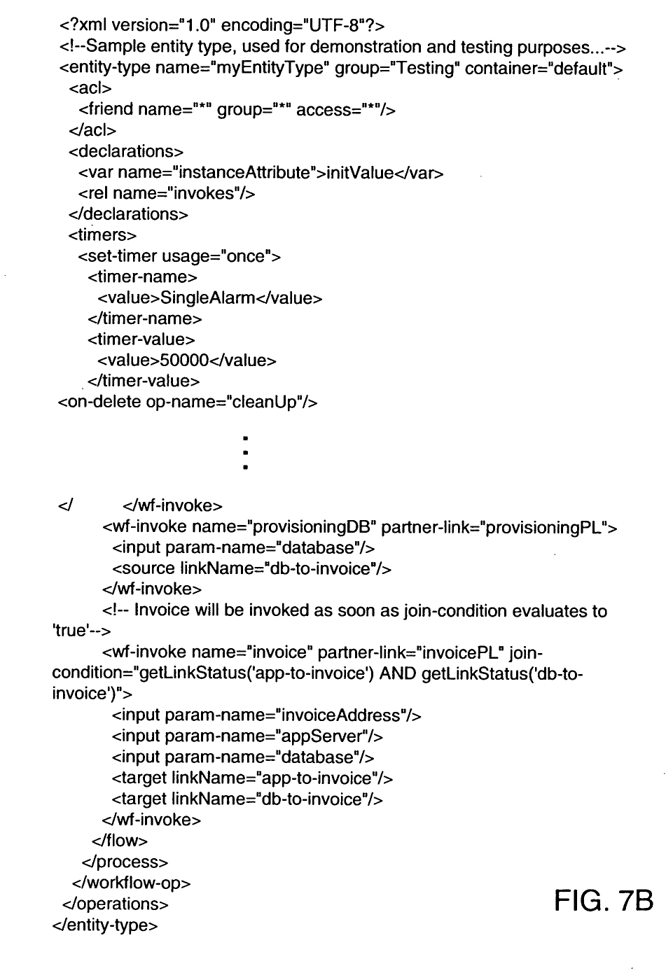

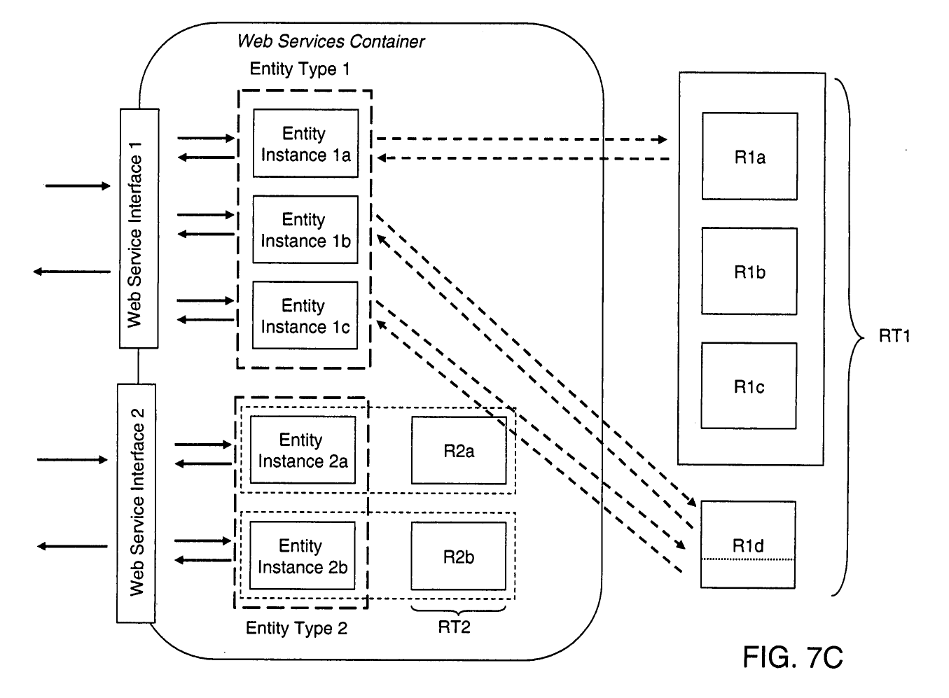

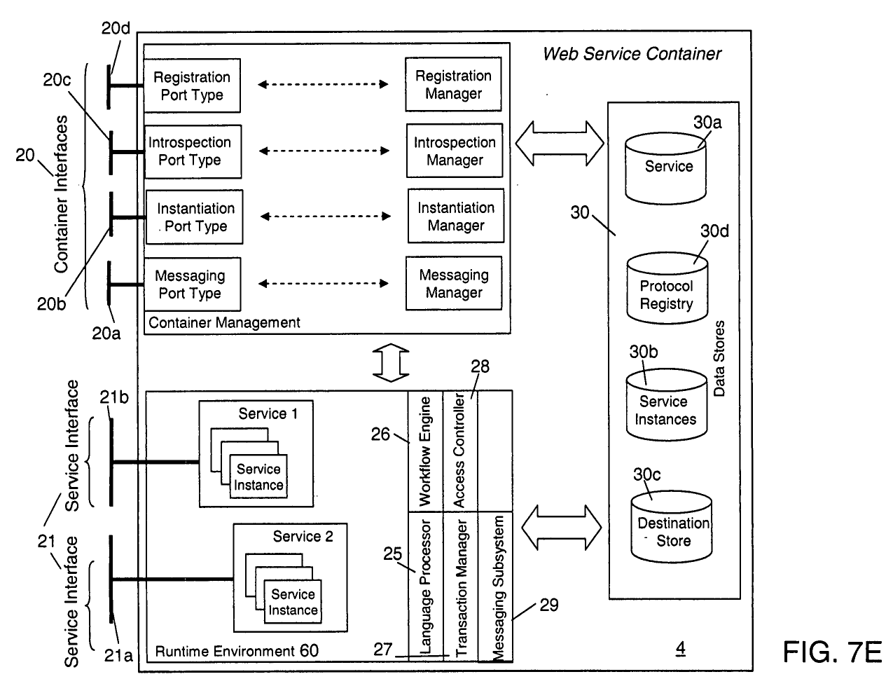

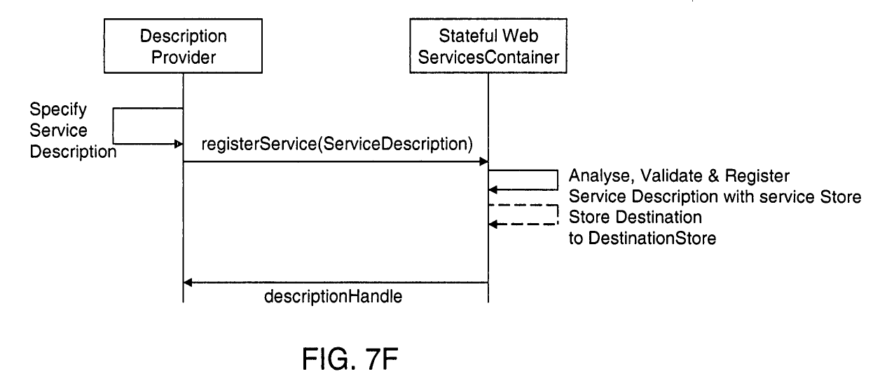

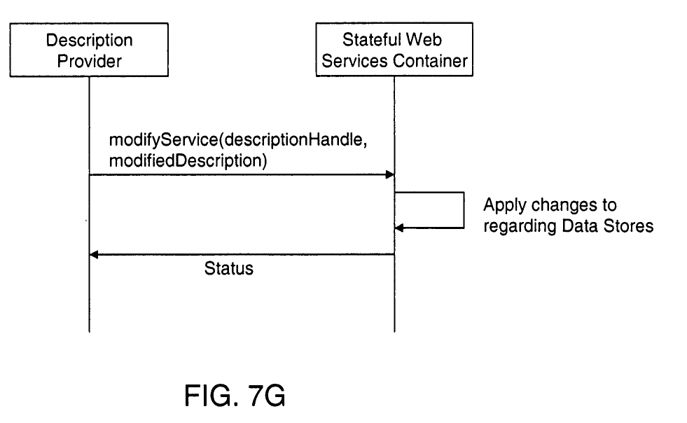

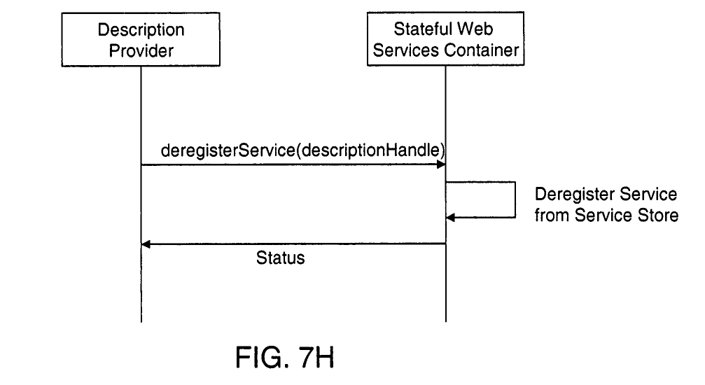

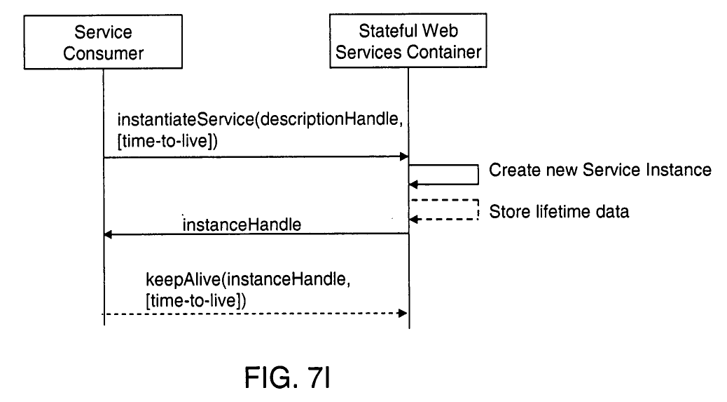

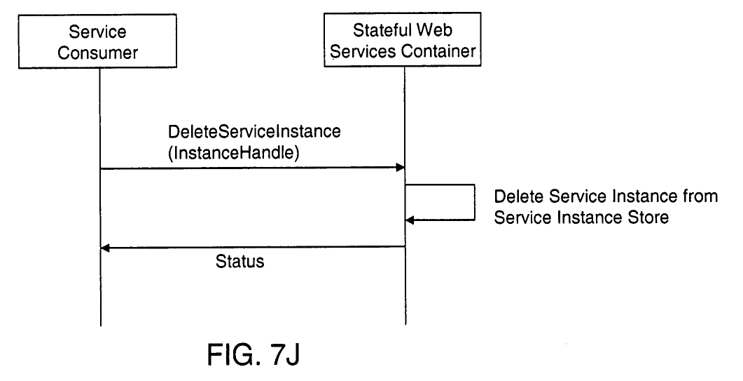

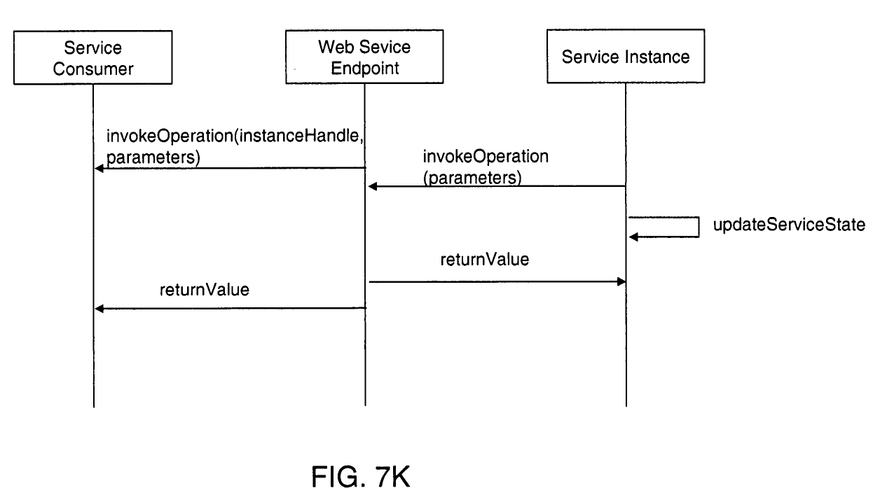

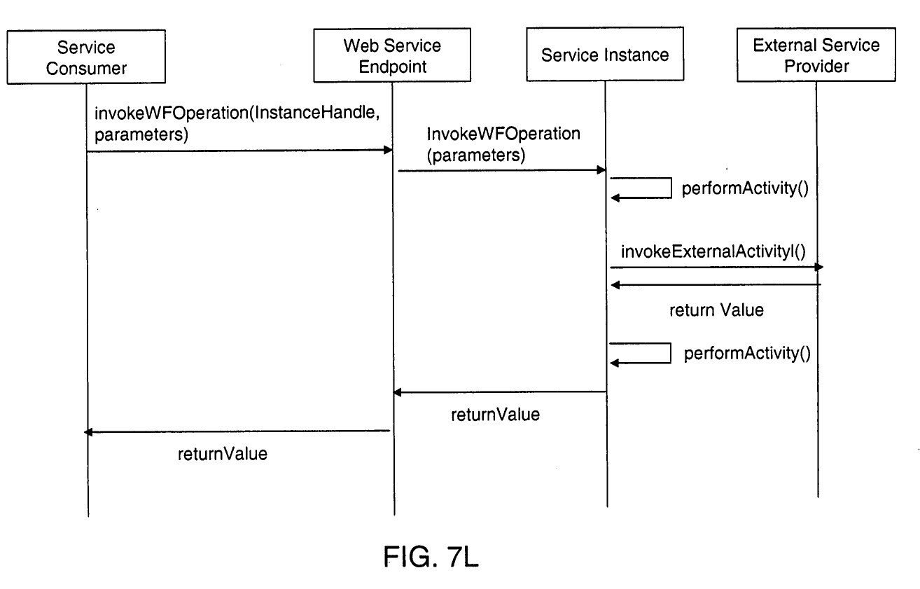

FIGS. 7A-7L show a preferred embodiment of the inventive system and method for dynamic deployment of services in a Web service architecture using a Web service container.

A Web service container represents the hosting environment of a Web service for life cycle management of the service implementation, concurrency management of method invocations, persistence and transaction services. Completing these services it may also support topic based messaging and security.

In that preferred implementation, services are deployed into the Web service container in a declarative description language, wherein said declarative description language is modeled by using entity type descriptions.

An entity type is described by means of a declarative description language and presents a service-oriented representation of any conceivable resource type. As the service-oriented representation of the resource is done in an abstract manner, an entity type may be mapped to any conceivable realization of a service-oriented architecture (i.e. stateful Web services).

FIG. 7A illustrates the relationship between a resource type, the corresponding entity type and one possibility to expose the entity type to a potential service clientele. The entity type provides an abstract service-oriented representation of the resource type and defines how a certain resource type shall be exposed in a service-oriented world. This decoupling of resource and entity allows one to define on a fine-granular level which of the resource type's attributes and, thus, which state information shall be made available. The hosting environment, e.g. the stateful Web services container, then automatically exposes the abstract service representation using Web service standards.

This approach to resource modeling combines several advantages. First of all, it decouples the actual resources types from the entities used to produce an abstract service representation of the resource and their state. Secondly, it makes it possible to use service implementations other than Web services to expose the resource's state. And thirdly, it provides a unified view of all sorts of resources, since they can all be accessed using the service interfaces that are automatically exposed.

Resources, be they logical or physical, can be described in a declarative manner using a declarative description language the grammar. The resulting entity type description represents the resource type in an abstract and service-oriented manner (see example of such a description in FIG. 7B). Since an entity type description only defines an abstract service-oriented representation of a resource type, it must be transferred into the Web services container, which automatically binds the entity type to a corresponding Web service interface and offers lifetime management operations in order to register new and deregister existing entity type descriptions. Following this line of reasoning, any entity type description has an individual life.

First of all and before a resource type can be represented or exposed through a Web service interface, an entity type description of the respective resource type must be specified. This is done using the <entity-type> element, its sub-elements, and the attributes. Usually, an entity type description includes a name, a group, several operations and relationships to other entity types. After such an entity type description has been derived from the resource type to be represented and the decisions on which state information to expose have been reached, the created entity type description can be registered with the Web services container. As a result of a registration, the Web service container will make the entity type's service interface available to potential service consumers and expose an individual Web service interface for every new entity type that is registered. In addition, every registered entity type description is assigned a universally unique identifier, which allows for further referencing and instantiation. This service perspective on every deployed resource capitalizes on the advantages of SOAs, namely cross-border and platform-independent interoperability, and thus provides a uniform service view of the represented resource types in a standardized manner. As soon as an entity type has been registered with the Web services container, it is offered for instantiation via the respective lifetime management operations of the Web services container.

In the simplest case, the Web service container simply instantiates the desired entity type without any further parameters or implicit assumptions. This results in a new entity instance that is accessed via the entity type's Web service interface being created by the hosting environment. If such an entity instance is not needed any more, it has to be explicitly deleted using the container's destroy interface. In cases where explicit entity instance deletion is not appropriate (e.g. because of its error-proneness, unreliable network connections or simply because it could be forgotten) the Web services container also offers instantiation with soft-state management semantics as known from OGSA. Hence, the container can be told to instantiate an entity type with a given time to live. This can be done by specifying either a future date and time until which the instance will have to be alive or simply by declaring an amount of milliseconds for the duration of which the instance is allowed to live. In case an instance is needed for a longer timeframe than specified when it was instantiated, the Web services container also offers a keep alive operation, which allows for the definition of a new time to live for a dedicated entity instance. This has the advantage that the container is in charge of instance destruction and service consumers can simply forget about instances, which are not used any longer.

After an entity instance has been created and also assigned a universally unique identity, it can be accessed via the Web service interface of its underlying entity type. This makes it possible to interact with the entity instance and thereby to retrieve state information, execute operations that operate on the entity instance's internal state or invoke other external service operations.

FIG. 7C depicts a possible set up of actual resources, entity instances and corresponding Web service interfaces. The Web services container 4 hosts two Web services (e.g. stateful) each of which conforming to a different entity type and being exposed through their individual Web service interfaces. The entity type that underlies Web service interface 1 provides a service-oriented representation of the resource type RT1. The entity type 2, which defines the Web service interface 2, represents resource type RT2. RT1 represents an existing physical or logical resource type the resource instances of which (R1a, R1b, R1c and R1d) can be remotely managed using some resource-specific protocol (indicated by the dashed arrows). RT2, in contrast, represents a purely conceptual resource type the resource instances of which (R2a and R2b) are hosted and made persistent directly inside the Web services container. Several entity instances have been created via the factory interface (not shown) of the stateful Web services container. In the case of entity type 1, these instances (entity instance 1a, entity instance 1b and entity instance 1c) act as proxies to externally located resources. It is important to realize at this point, that an entity instance cannot necessarily be associated with a single actual resource that represents an instance of the resource type, which is represented by the entity type. So-called virtualisation1 techniques allow for the clustering of several actual resources in order to cover the needs of a greedy service instance (entity instance 1a is served by a composite resource consisting of R1a, R1b and R1c) or allow that several entity instances are handled by one and the same actual resource (entity instance 1b and entity instance 1c both operate on R1d). Regarding entity type 2 and its entity instances, it can be said that since the actual resources are collocated with the entity instances, the resource state can be managed directly without any resource-specific protocols. In this case, when a new entity instance is created, the provisioning of the actual resource merely involves the creation of database tables or similar in order to make the resource state persistent. Whenever external logical or physical resources are represented the actual provisioning of the respective resource may be much more complicated and involve processes such as installation, hardware rebooting or changing network settings.

Entity operations may appear and be described in a twofold manner. On the one hand, it is possible to define simple, programmatic operations as known from traditional programming approaches.

These simple or trivial operations can be defined by means of prevalent programming constructs, operators, parameters and return statements. On the other hand, also so-called workflow-driven operations can be specified for every entity type. In contrast to the simple operations, these more complex declarative programming constructs follow more comprehensive semantics as known from various workflow methodologies. They are especially well-suited to define, manage and monitor any type of control flow that governs how a given set of individual activities or tasks have to be serialized, parallelized or synchronized. Concerning the exposure of these distinct sorts of entity type operations, an external Web service consumer shall not be able to distinguish between the two operation types. Whilst the Web service interface does not expose a difference between them and makes their inherent distinction transparent to its client, the implementation of these operations does well make this difference. Hence, the language processor will execute them with differing semantics in two distinct operation modes.

FIG. 7D describes the components of the Web service architecture.

The first and most prominent component represents the Web services container 4 which is preferably a stateful Web service container. Even though, at first sight, one might not consider the hosting environment itself as representative of an individual role, it is considered as such since the container is associated with a number of responsibilities. In particular, it is responsible to provide a set of Web service interfaces to the outside, which allow potential description providers to register or deregister descriptions of new entity types. In addition, it has to expose interfaces that enable service consumers 2 to create, manage, combine and destroy entity instances in various ways. In order to allow service consumers 2 to instantiate and use the registered entity types, the container must also provide a query interface that allows one to retrieve information about the registered descriptions and existing entity instances (e.g. unique handles for referencing). Moreover, the Web services container 4 must provide a managed runtime environment for entity instances and is responsible for the automatic exposure of their Web service interfaces, which conform to the corresponding entity type descriptions. Further, the container 4 is responsible to durably store registered entity types as well as instance state. In cases, where the entity instances represent external resources, the container additionally needs to assure that the state of the resource is reflected within the entity instance and can be accessed by interested service consumers.

Resource Provider 13

The responsibility of the resource provider component 13 is to offer any kind of resource that may be described later on by an entity type description. The resources provided by a resource provider 13 need to be accessible by means of a resource-specific protocol.

Description Provider 3

The description provider 3 is responsible for creating new entity types by describing them with a declarative language. Further, the description provider 3 is also responsible to register the newly specified descriptions with the Web services container via its dedicated registration interface. As a result of the architecture, the provider of entity type is relieved of the tedious and error-prone deployment process as know from the traditional approach.

Instead of coding, compiling, describing, packaging and finally transferring the executable into a pre-defined place within the hosting environment, the description provider only needs to invoke a dedicated registration operation on the Web services container's own interface and pass the description as invocation parameter.

Service Consumer 2

As soon as a description provider 3 has registered a new entity type description, new entity instances based on this entity type can be instantiated. This creation of new entity instances is the responsibility of the service consumer 2. In order to instantiate an entity type, the service consumer 2 must first query the Web services container's information retrieval interface and obtain a handle that references the desired entity type description. After instantiation, a service consumer 2 obtains a unique instance identifier and may subsequently interact with the entity instance via its Web service interface, which is derived from and compliant with the entity type. Using the Web service interface of the underlying entity type, a service consumer may invoke any exposed instance operation and thus change the entity instance's inherent state. Unless the entity instances have been created using the container's soft-state management interface, the service consumer 2 will eventually also have to delete existing entity instances that are not used any more.

External Messaging Sources and Sinks 15

Since the stateful Web services container shall not only support sending and receiving asynchronous messages between entity instances living inside the hosting environment, but also between the Web services container 4 and external parties, there exist the roles of an external messaging source and an external messaging sink respectively. In the case of an external messaging source, an arbitrary component is able to create new messaging destinations through the container's messaging broker interface. As a result of existing messaging destinations, the external messaging source is allowed to register for publication with any existing messaging topic or queue. Whenever certain events occur on part of such a registered messaging source, a new message indicating the occurred event will be published to the respective destination via the container's messaging broker interface. Regarding the external messaging sink role, an external system component is allowed to create new destinations or subscribe for any existing destinations of interest. This will result in the external messaging sink being notified whenever a message is published to the respective messaging destination.

External Services Provider 16

As the hosting of stateful Web services implies, the Web services container 4 offers its services following the requirements of a service-oriented architecture. Because entity instances living inside the hosting environment may also act like services living inside a SOA, they may comprise functionality, which is not implemented within the entity itself but provided by another service. Such encapsulated functionality may be offered either by another entity instance living in the same container or by an external services provider that implements the desired function. While the former of these two methods only concerns functionality provided by entity instances that live within the same container and can be addressed using previously established relationships, the latter includes invocations of external services. Such services, provided by external service providers, may be invoked from within an entity instance's both simple as well as workflow-driven operations.

Web Services Container Components 4

After the individual components, which are involved in the general architecture of the dynamically deployable stateful Web services container, have been described, this section shall now look more closely at the individual components that are responsible to realize the capabilities of the entities' hosting environment. As an aside, it is important to note that the following decomposition of the stateful Web services container into single components must be regarded as neither prescriptive nor implementation-specific. Saying this, the components as described in the following represent one possible approach how the responsibilities of the container could be reflected in an applied architecture. This does not mean that any of these parts (except for the container's interfaces) need to be represented by a concrete counterpart in an actual implementation of the stateful Web services container, but only serves to elucidate the responsibilities of the hosting environment in more detail and to make these explanations more tangible.

FIG. 7E shows a schematic illustration of the respective parts and the relations among them.

Container Interfaces 20 (20a-20d)

As mentioned earlier, the container's functionality is exposed in a service-oriented manner through a well-defined Web service interface 20. The interface is grouped into a number of port types (20a-20d), which provide sets of concrete operations to service consumers. An overview of the container's Web service interface's port types and the respective operations is depicted in FIG. 7E. Note that at this point the operations are only described in brief. An in-depth demonstration of how to interact with these operations, which parameters to pass and what return values to expect will be given in description to FIGS. 7F-7L.

Of course, the functionality exposed by the stateful Web services container's port types must be realized by an internal implementation of the offered services. In FIG. 7F this is denoted schematically by the respective manager components. They represent the parts within the architecture, which are equally responsible to interact with the persistence layer (i.e. the data stores) as well as the service runtime environment.

Service Interfaces 21 (21a/b)

The Web service interface 21 of an arbitrary entity type depends largely on the underlying entity type description. As shown previously, the entity type description allows one to define whether or not a concrete operation is to be exposed as Web service operation. The set of all operations, which were declared to be exposed, can be accessed through the entity type's Web service interface 21 as soon as there is at least one entity instance that belongs to a given entity type. However, in addition to the declared entity instance operations, two more instance operations will be exposed by default. On the one hand, a getEntityType operation, which will return the underlying entity type of the queried entity instance and, on the other hand, a getRelationships operation, which will inform a service consumer about all relationships in which the respective entity instance participates.

A concrete example of an entity type description as well as its corresponding external Web service interface can be found in FIG. 7A.

Runtime Environment 60

After a new entity type description has been registered and instantiated, the entity instance will be living in the Web services container's service runtime environment 60. An entity instance exists within the runtime environment and can be used through the Web service interface 21 corresponding to the underlying entity type until it is deleted. As shown earlier, deletion of an entity instance can be initiated by an external service consumer invoking a deleteInstance operation on the container's Web service interface, by an entity instance using a dedicated operator, by the runtime environment 60 itself because the entity instance acts in a contains relationship in the role of the dependent content or because the entity instance has been instantiated with a given lifetime, which has elapsed. As entity instances are potentially stateful, the runtime environment 60 is also responsible to make sure that all data pertaining to either entity instances or relationships between them are automatically made persistent to the respective data stores. Furthermore, the runtime environment 60 closely interoperates with the Transaction Manager in order to ensure that invoked operations are being executed under the correct transactional context where this is necessary. In addition, the runtime environment 60 is responsible to associate new entity instances and relationships with universally unique references and to invoke the correct call-back operation (that was declared and mapped to the on-init element) on the entity instance instantaneously after the instance has been created. In analogy to this, the runtime environment 60 also assures to invoke the respective on-delete call-back operation as declared in the entity type description. Likewise, also timeouts of declared and initiated timers will result in the invocation of the correct entity instance operations. Further, the runtime environment 60 interoperates with the messaging subsystem of the container and is thus responsible to deliver asynchronous notifications to all message-consuming entity instances that have subscribed for the respective destinations and to invoke the correct operations on them.

Language Processor 25 and Workflow Engine 26

Since the declarative service descriptions, which are submitted to the Web services container through the register operation, are specified in any declarative language, the container needs to have a language processing unit, which is able to interpret the submitted entity type descriptions. To begin with, the language processor is responsible to analyze, verify and validate submitted descriptions. After instantiation, the language processor 25 executes and manages operation invocations on individual entity instances. Such invocations of entity instance operations must be executed in either simple operation mode or workflow-driven operation mode. In the case of workflow-driven operations, the operations will be executed by a workflow engine 26, which is a subsystem of the language processor 25. The workflow engine 26 ensures seamless integration with the transaction manager to handle long running transactions and enables undoing the effects of previously terminated sub-tasks by allowing and managing compensation activities.

Transaction Manager 27

The transaction manager 27 is responsible to handle and manage the creation, execution and destruction of coordination and transactional contexts. This involves the creation of new transactional contexts when a transactional operation is invoked as well as the management of running transactions and existing contexts. In the case of the simple operations, the transactions are always considered executing under ACID characteristics.

In the case of workflow-driven operations however, transactions are assumed to execute using the state model as defined in the Web services business transactions framework 26. Because in long running transactions that often happen when individual Web services interact, atomicity and isolation of the distributed transaction cannot be efficiently Met, this model softens the strict ACID requirements and merely demands that long running transactions, as used in the case of workflow-driven operations, have to ensure consistency and durability. In addition, these transactions take into account that workflows may define compensating activities that may reverse the effect of a previously successfully terminated activity in case some other task of the overall workflow, from which the eventual outcome depends, fails.

Access Controller 28

The access controller is responsible to ensure that only entity instances the entity types of which are specified in the access control list are actually granted access to an individual operation on the target entity instance. In addition to this, the access controller is also responsible to administer groups of entity types, which collectively have access to a predefined set of operations on a given instance of certain entity type.

Messaging Subsystem 29

In order to enable container-brokered asynchronous notifications among entity instances and external messaging clients, the Web services container also provides a message broker (not shown) being part of its respective messaging subsystem 29 that builds on the features of traditional messaging subsystems and exposes its external broker interface via the messaging port type. Through its internal message broker, the messaging subsystem 29 acts as a bridge between the external and internal messaging clients (message providers and consumers alike) and ensures to durably store destinations, subscriptions, registrations as well as published messages if a messaging consumer was available when a message pertaining to it was published.

In order to ensure compatibility with emerging Web service standards, the message broker's Web service interface could be expanded to conform with the Web services notification specification 17, which has been released recently. However, this bears the disadvantage that messaging destinations of the type queue would not be supported any more.

Data Stores 30

In order to address the stateful properties of the Web services container, the container must provide a set of data stores 30, which are responsible to make all various information persistent. A brief description of the respective data stores is given in the following:

Entity Type Data Store 30a

The entity type data store is responsible to retain all previously registered entity type descriptions until they are either deregistered or modified. Modifications to an entity type must be reflected in both the entity type data store 30a as well as within the entity instances that correspond to the respective entity type. In cases where an entity type with living entity instances is modified, the changes must also be reflected in the entity instance store or the underlying concrete resource (in case of an actual resource being modeled). Entity types that have been successfully registered with the container and made persistent within the entity type store are made available for subsequent instantiation.

Entity Instance Store 30b

If a new entity instance is created from a previously registered entity type, the entity instance data store 30b is responsible to hold all state data pertaining to this individual entity instance.

Destination Data Store 30c

The destination data store 30c comprises all information pertaining to asynchronous container-brokered messaging. This includes messaging destination (i.e. topics and queues), subscriptions to as well as registrations with existing messaging destinations. In cases, where subscribed message consumers are temporarily not available, the destination store is also responsible to store messages to such messaging sinks in order to allow the message broker to send the missed messages after a respective client becomes available again.

Protocol Registry 30d

Since the Web services container must be as flexible and extensible as possible with regard to resource-specific protocols, the architecture provides the possibility to dynamically register support for new resource-specific protocols with the hosting environment. This makes it possible that the language processor can process also novel protocols, which haven't been known earlier. In order to store newly registered protocols, the container offers a protocol registry, which is used together with dedicated protocol registration interface operations2.

FIG. 7F shows the interaction for registering a entity type description.

In order to register a new entity type description, first of all, a description provider specifies a new entity type description that describes the behavior of any kind of resource of his choice (i.e. conforming to some kind of physical or logical resource) The description of the new entity type can be done automatically (using templates from a template or parts repository) or manually by specifying a new description from scratch. Having declared a new entity type, the description provider may invoke the registerEntityType operation of the Web services container's registration port type and thereby tells the hosting environment to register the transmitted entity type description. Subsequently, the container analyses, validates, and registers the description representing a new type of stateful resource with the entity type store. After successful registration, the novel entity type is offered for instantiation. If the description also comprises the declaration of new destinations, these are stored to the destination store of the container's broker. As a result of a successful registration, the Web services container will return a universally unique description handle (referring to the registered entity type) to the description provider. In case of failure, the container shall return a fault code instead.

FIG. 7G shows the interaction for modifying an existing entity type.

As FIG. 7E shows, the Web services container's registration port type also allows one to modify existing entity types during runtime. In order to expand or minimize an entity type's interface a description provider may choose to invoke the modifyEntityType operation, passing the description handle pointing to the respective entity type description and the modified entity type description as parameters. In consequence, the Web services container modifies the existing entity type and the corresponding entity instances to suit the submitted modifications and stores the changes to the pertaining data stores. In consequence, the container will return a status code that indicates whether the modifications have been successfully adopted.

FIG. 7H shows the interaction for deregistration of an existing entity type.

If an existing entity type is not needed any more (i.e. there are no entity instances left that belong to this entity type), a description provider may choose to invoke the deregisterEntityType operation and pass the description handle pointing to the desired entity type description, which is to be deregistered. The Web services container will subsequently deregister the description from the entity type store. In the following, the description provider will receive a status code indicating whether the deregister operation was successful.

Instantiation and Destruction

After entity type has been registered with the container, they can be instantiated and used. Instantiation and modification of new instances can be done via the Web services container's instantiation port type. The operations that belong to this port type are described in the following subsections.

FIG. 7I shows the interaction for instantiating an entity type.

In order to instantiate a registered entity type, a service consumer may invoke one of the Web services container's instantiateEntityType operations and pass the description handle, which refers to the entity type that is to be instantiated, as parameter. If the instance was created with a given lifetime, the Web services container shall also be responsible for the destruction of the entity instance after the indicated time has elapsed. For this reason and in order to manage every individual instance's lifetime, the lifetime data must be made persistent together with the entity instance's initialization data (as declared in the underlying entity type description). If the instantiation process was successful, the Web services container will associate the new entity instance with a universally unique instance handle that will be returned to the service consumer. If the instantiation fails, this will be indicated by returning a fault code to the service consumer. In cases where a new entity instance was created with a given time-to-live and the respective instance is needed for a longer time than previously set, a service consumer may choose to (repetitively) invoke a keepAlive operation and indicate the target instance the lifetime of which is to be prolonged. Optionally, the service consumer may also specify a new time-to-live after which the entity is to be removed.

FIG. 7J shows the interaction for deleting an entity instance.

If at some point of time an existing entity instance is not needed any more it can be explicitly destroyed using the instantiation port type's deleteEntityInstance operation. When the operation is invoked by a service consumer, the instance handle that references the entity instance, which is to be deleted, must be passed as a parameter. If the service consumer is authorized to perform this operation, the Web service container will invoke the entity instance's on-delete call-back operation and subsequently remove the respective instance from the hosting environment's entity instance store. In consequence, the service consumer will receive a status code that indicates whether or not the delete operation has been successful.

Service Use and Interaction

As soon as a registered entity type has been instantiated for the first time and as long as there is at least one entity instance that corresponds to a given entity type, the individual entity instances can be accessed through the Web service interface of their underlying entity type. These service specific interfaces are accessible on their individual endpoint within the hosting environment. In addition to the service-specific operations, which were specified in their entity type descriptions, every individual Web service interface offers at least two additional operations. Firstly, an operation that returns the entity type of a given entity instance and, secondly, an operation that returns all relationships (both implicit as well as explicit) in which the respective entity instance participates.

FIG. 7K shows the invocation of a simple instance operation.

In order to demonstrate how a dedicated entity instance may interact with a service consumer, this subsection provides an example where a service consumer invokes a simple operation on an entity instance. Before the service consumer may interact with a given instance, first of all, the consumer must obtain an instance handle that refers to the desired entity instance and the endpoint reference where the underlying entity type's Web service interface can be accessed. As will be shown in the next section, for this purpose, the container offers a special introspection port type, which allows an interested service consumer to collect the needed information. As soon as the service consumer has obtained the required information, it may freely access any one of the exposed entity instance's operations through the respective Web service interface. This is done by addressing the Web service endpoint and invoking the desired operation and providing the instance handle as well as the further necessary parameters. As a result the container-managed Web service endpoint will intercept the call and will route the operation invocation to the desired entity instance. As a result of the operation being invoked, the respective entity instance may change its internal state and return the result of the invocation to the entity consumer.

FIG. 7L shows the invocation of a workflow-driven operation.

In analogy to invoking a simple instance operation, a service consumer may also choose to invoke a workflow-driven operation that is defined on a given entity instance instead. As in the simple operation case, the service consumer must also provide an instance handle as well as possible parameters when invoking the operation. When the operation is finally executed on the target entity instance, it performs the activities as prescribed in the respective entity type description. This may also include external workflow activities that are executed under a long-running transaction context. Like the simple operations, also workflow-driven operations can eventually return a result to the service consumer. Although, in most cases, it might be more sensible to use an asynchronous notification to inform a service consumer about a result since this does not require blocking on the part of the service consumer.

The present invention can be realized in hardware, software, or a combination of hardware and software. A tool according to the present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following: a) conversion to another language, code or notation; b) reproduction in a different material form.

### Definitions

Dynamic Deployment of Services:

A system supporting dynamic deployment provides a mechanism that takes the source code provided by a developer or an application and dynamically installs it in the target service container (i.e. hosting environment) without further user interaction and without restarting the application server. Thus, the application is made available to its users or service consumers.

Entity Type:

An entity type is described by means of a declarative description language and presents a service-oriented representation of any conceivable resource type. As the service-oriented representation of the resource is done in an abstract manner, an entity type may be mapped to any conceivable realization of a service-oriented architecture (i.e. stateful Web services).

Entity Instance:

An entity instance represents an abstract service-oriented instance and may be associated with a given concrete resource instance. Any entity instance has an underlying entity type, has an identity (assigned to the instance by the hosting environment), follows a life cycle, and assigns concrete values to the attributes defined by the entity type.

Resource Type:

Any actual resource instance (physical or logical) has an underlying resource type, which captures the essential characteristics of the respective resource, namely the functionality it provides (e.g. text-processing, copying, cutting, pasting of a document), the attributes it includes (e.g. name of the processed document, has the document been stored already, content of the clipboard) and the possible states it allows for these attributes.

Resource Instance:

A concrete resource instance must be regarded as an instance conforming to a resource type. It has a well-defined identity and holds state information, i.e. it defines a value for each of the resource's attributes.

Service Container:

The service container i.e. hosting environment), which is preferably a stateful service container, offers a managed runtime environment and provides transparent transaction handling, persistence, a messaging subsystem and a workflow engine, which controls the execution of the service instance's workflow-driven operations. This service container can run on any kind of data processing unit like a normal PC, a special server etc. that have a processor, working memory, secondary storage and ideally network (wired or wireless) access).

Web Service:

A Web service is a software system designed to support interoperable machine-to-machine interaction over a network. It has an interface described in a machine-processable format (e.g. using (WSDL)) and allows other systems to interact with it in a prescribed manner (e.g. using so-called SOAP messages).

Stateful Web Service:

Stateful Web services consist of an interface representing the type of the service (described by WSDL), as well as zero to many service instances, being accessible through the interface, having an identity and following a well-defined life cycle. The service instances maintain internal state and as such represent finite state automata as the effect of a service operation may depend on the internal state of the service instance. Similar to a grid services, stateful Web services define interfaces for discovery, dynamic service creation, lifetime management, notification and general manageability.

Service-Oriented Architecture:

A service-oriented architecture consists of a least one service container, service consumer, resource provider, and description provider. All these players are connected via a network and communicate or exchange information within this architecture.

What is claimed is:

1. A method for deploying services into a service container that is part of a service-oriented architecture, wherein said service container is characterized by providing an own registration service for deploying services during runtime into said service container, wherein said registration service comprises at least the steps of:
receiving a service description from a description provider, wherein said service description represents a service of a resource and is modeled in a declarative description language; and
automatically creating and offering a service interface for said service description at said service container if said service description has been registered successfully, wherein said service interface allows access to a service represented by said service description.

2. The method of claim 1, wherein said registration service further comprises the step of:
analyzing and validating said service description before exposing a new service interface.

3. The method of claim 1, wherein said registration service further comprises the step of:
returning a unique description handle (ID) referring to said service description to the description provider if said service description has been registered successfully.

4. The method of claim 1, wherein said service container is further characterized by providing a retrieval service for retrieving information about registered services, wherein said retrieval service comprises the steps of:
in response to a retrieval request of a service consumer, providing a list of description handles referring to services already registered; and
in response to a request of a service consumer including a description handle, providing a service description to said service consumer.

5. The method of claim 4, wherein said retrieval service further comprises the step of:
in response to a request of a service consumer, providing service interface information to said service consumer.

6. The method of claim 1, wherein said service container is further characterized by providing an instantiate service for initiating a registered service, wherein said instantiate service comprises the steps of:
in response to an instantiate request of a service consumer containing at least a description handle referring to a registered service, creating a new service instance and registering said new service instance; and
providing a unique instance handle to the service consumer if the instantiation has been successful.

7. The method of claim 6, further comprising the steps of:
receiving an instance handle from said service consumer;
providing a description handle to said service consumer which refers to a service of said service instance;
in response to a request of said service consumer containing said description handle, providing a service interface to said service consumer;
intercepting an operation invoked by said service consumer at said service interface and routing it to a correct service instance;
interpreting an operation invoked by a runtime environment of said service container according to the service description.

8. The method of claim 1, wherein said service container is further characterized by providing an instance delete service allowing a service consumer to delete an instance that is not used anymore.

9. The method of claim 1, wherein said service container is further characterized by providing a deregister service description service for deregistering service descriptions that are not used anymore.

10. The method of claim 1, wherein said service container is a stateful Web service container.

11. The method of claim 1, wherein said service description is modeled by using entity type descriptions.

12. A computer program product stored on a computer usable medium comprising computer readable program means for causing a computer to perform the method of claim 1 when said computer program product is executed on a computer.

13. A service container in a service-oriented environment comprising:
a registration service interface which allows a description provider to register a service description, wherein said service description represents a service of a resource in a declarative description language; and
a service interface which is assigned to a service description and which is automatically created when said assigned service description has been successfully registered via said registration service interface.

14. A service container according to claim 13, further comprising:
a component for analyzing and validating a service description before automatically creating and assigning a service interface to said service description.

15. A service container according to claim 13 further comprising:
an information retrieval service interface which is used to query said service container about deployed services or service instances; and
an instantiation service interface which allows a service consumer to instantiate a service description provided by said service container.

16. A service container according to claim 13, further comprising:
a service description data store containing service descriptions already registered with said service container;
a service instance data store containing instances that belong to services in said service description data store.

17. A service container according to claim 13 further comprising:
a deregister description service interface which is used to deregister service descriptions that are not used any more; and
a delete service instance interface allows a service consumer to delete an instance that is not longer used.

18. A service container according to claim 13, further comprising:
a workflow engine that manages the execution of workflow-driven operations provided by said service instances;
protocol-specific interfaces for communication between said service container and modeled resources.

19. A service container according to claim 13, wherein said service-oriented environment further comprises a resource provider, a service consumer, a description provider, wherein said service-oriented environment uses a Web service protocol.
